(19) United States
(12) Patent Application Publication
(10) Pub. No.: US 2011/0037419 A1
(43) Pub. Date: Feb. 17, 2011

(54) Device Operation Using a Force Sensor

(75) Inventors: Peter F. Hoffman, Avon, OH (US); John D. Crawford, Avon, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: EVEREADY BATTERY COMPANY, INC., St. Louis, MO (US)

(21) Appl. No.: 12/899,618

(22) Filed: Oct. 7, 2010

Related U.S. Application Data
(63) Continuation of application No. PCT/US09/02205, filed on Apr. 8, 2009.
(60) Provisional application No. 61/043,471, filed on Apr. 9, 2008.
(60) Provisional application No. 61/098,818, filed on Sep. 22, 2008.

(51) Int. Cl. H05B 37/02; G01L 1/10

(52) U.S. Cl. 315/313; 73/862.625; 315/362

(57) ABSTRACT

An electrical device operates by performing actions based on identified events. The device includes a list of events within a memory, a sensor that measures a force on the sensor to provide measurement information, a list of actions, a control component, input output, a load, an action identifier, and an action bank. The list of actions can be stored in the action bank. The control component is coupled to the sensor and identifies an event from the measurement information and selects an action based on the identified event.

### RELATED APPLICATIONS

This application is a continuation of International Application No. PCT/US09/002205, filed Apr. 8, 2009, which claimed the benefit of U.S. Provisional Application No. 61/043471, filed Apr. 9, 2008 and of U.S. Provisional Application No. 61/098,818, filed Sep. 22, 2008, the contents of which are incorporated by reference.

### TECHNICAL FIELD

The following generally relates to a device with force sensing, and finds application to a battery powered lighting device. However, the following is also amenable to other battery powered and to non-battery powered electrical devices.

### BACKGROUND

Lighting devices such as flashlights, headlights, lamps, etc. generally are controlled (turned “on” and “off”) based on user input (e.g., a switch), light level (e.g., a photo-detector), motion (e.g., a motion detector), and/or time (e.g., a timer). As a consequence, there is an unresolved need to control lighting devices based on other inputs.

### SUMMARY

Aspects of the application address the above matters, and others.

In one aspect, a battery-powered device includes a battery receiving region that receives a battery, a load that is powered by the battery, a sensor that measures an external force on the sensor, and a control component that selectively supplies power from the battery to the load based on the sensed forced.

In another aspect, a battery-powered flashlight includes a battery receiving region that receives a battery, a light source that is powered by the battery, and an integrated chip (IC). The IC includes control circuitry and a MEMS based accelerometer, wherein the MEMS device determines an external force on the accelerometer, and the control circuitry controls the light source based on the force.

In another aspect, a method includes determining an external force on a battery powered lighting device via an accelerometer of a MEMS device and controlling a light source of the device based on the external force.

In another aspect, an electrical device operates by performing actions based on identified events. The device includes a list of events within a memory, a sensor that measures a force on the sensor to provide measurement information, a list of actions, a control component, input output, a load, an action identifier, and an action bank. The list of actions can be stored in the action bank. The control component is coupled to the sensor and identifies an event from the measurement information and selects an action based on the identified event.

In another aspect, a method is disclosed. An event is sensed to generate measurement information. The event is identified based on the measurement information. An action is identified based on the identified event. The identified action is performed. In one example, a sensor is employed to generate the measurement information. The event can be selected from a list or group of events, for example, including dropping, tilting, shaking, shock, inclination, and temperature. The identified event can be identified by correlating the measurement information to the identified event.

In another aspect, a headlight device is disclosed. The headlight includes a light housing, a strap, a sensor, and a control component. The sensor provides measurement information. The control component identifies a tilting position of the light housing from the measurement information and selects an action based on the identified tilting position. In one example, the position is substantially horizontal and the action is to emit a relatively narrow beam angle. In yet another aspect, a headlight identifies hand gestures and operates according to the identified hand gestures.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 illustrates an example electrical device;

FIG. 2 illustrates the example lighting device;

FIG. 3 illustrates an example method;

FIG. 4 illustrates a method of operating a device;

FIG. 5 illustrates a method of mapping events;

FIG. 6 illustrates a method of correlating actions to events;

FIGS. 7A, 7B, and 7C illustrate an example of events and actions for a lighting device;

FIGS. 8A and 8B illustrate an example of events and actions for a headlight lighting device; and

FIGS. 9A and 9B illustrate an example of events and actions for a lantern lighting device.

### DETAILED DESCRIPTION

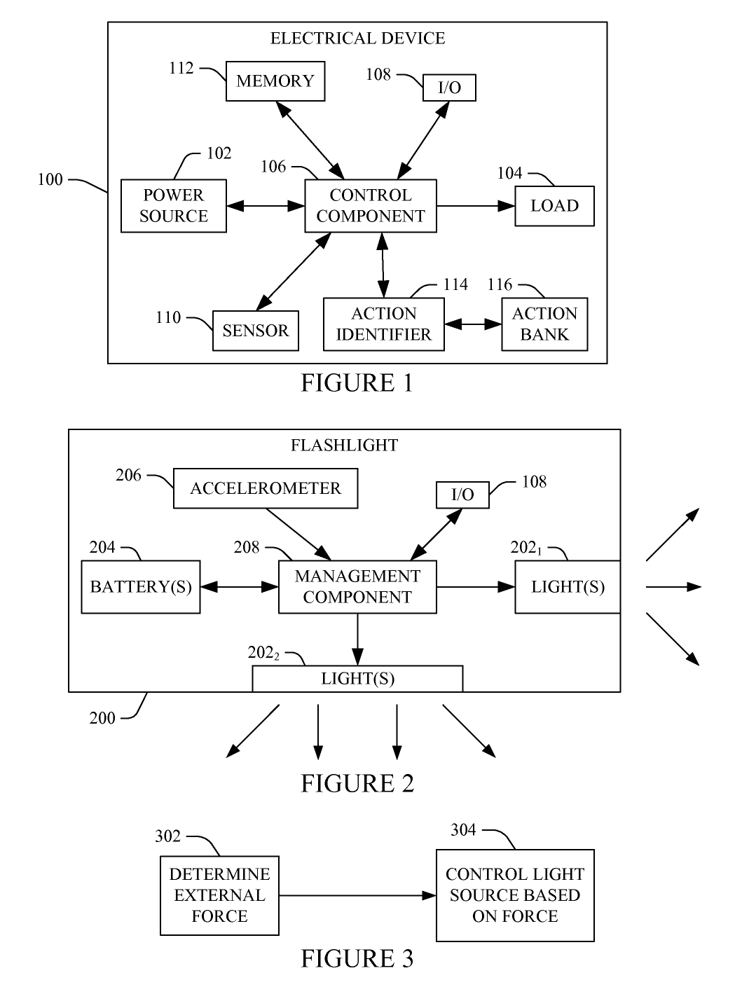

Initially referring to a system shown in FIG. 1, an electrical device 100 includes a power source 102 and a load 104, which is powered by the power source 102. The power source 102 may include one or more batteries and/or other sources, and the load 104 may include one or more light sources and/or other electrically powered component(s). Examples of suitable light sources include, but are not limited to, one or more light emitting diodes (LEDs), incandescent lamps, fluorescent lamps, halogen lamps, etc.

A control component 106 controls the load 104. In one non-limiting instance, such control is achieved by controlling the power supplied to the load 104 from the power source 102. For instance, the control component 106 may include and/or control a switch in the electrical current path from the power source 102 to the load 104. In this instance, the control component 106 may selectively open the switch to prevent current flow from the power source 102 to the load 104, close the switch to allow current flow from the power source 102 to flow the load 104, alternately open and close the switch, for example, at a preset frequency (pulse width modulation) to regulate current flow from the power source 102 to the load 104, etc. It is to be appreciated that the frequency can be periodic, aperiodic, and/or on demand, for example, based on a triggering event such as a user input, a state of the device 100, a parameter determined by the device 100, etc. The control component 106 may include one or more microprocessors. In another instance, the control component 106 identifies events and actions to be performed as a result. The action can include limiting or adjusting power to the load 104. Alternately, the action can involve logging an event or other activity that doesn't involve adjusting power to the load 104.

The device 100 also includes input and output (I/O) 108 such as an interface through which a user (e.g., human, robot, machine, etc.) can interact with the device 100. For instance, the I/O 108 may include a mechanical switch that can be move between two or more positions to thereby transition the device 100 between two or more different states. By way of non-limiting example, a suitable switch may include three different positions, an “off” position and two “on” positions, which correspond to different lights and/or light intensities. Suitable switches include rotary, push button, slide, etc. switches. Another suitable switch may be activated via an audible signal (e.g., speech), light level, motion, etc. The output portion of the I/O 108 may include visual and/or audible signals. For example, the device may include one or more light emitting diodes (LED's), a seven segment display, a liquid crystal display (LCD), etc., and/or a speaker. The output may also include a data signal such as an analog or digital signal that can be transferred over a wireless and/or wired connection, for example, via Universal Serial Bus, Ethernet, Infrared, FireWire, BlueTooth, and/or the like. Thus, it is appreciated that the components of FIG. 1 are not required to be present in a housing and can, instead, be separated. For example, the I/O can include a remote control communicating with the control component 106 within a housing. As another example, the control component 106 and the load 104 can be in varied housings.

A sensor 110 senses various information, referred to as measurement information about the device 100 and provides such information to the control component 106, which can use the information to control the power supplied to the load 104. The measurement information can include a time and/or duration. An identified or identifiable occurrence or sequence of measurements from the sensor(s) 110 is also referred herein as an event. The control component 106 may also store this information in a storage component such as memory 112 and/or provide access to this information through the I/O 108 via a wired and/or wireless connection. In one instance, the sensor 110 includes an inertial sensor, such as an accelerometer or other device that measures an external force on the sensor 110 due to acceleration, vibration, shock, tilt, inclination, temperature, etc., including single and multiple axis accelerometers.

It is also appreciated that the sensor 110 can be located in a separate housing from some or all of the other components.

The sensor 110 may be part of a Micro Electro Mechanical Systems (MEMS) device, which includes a micrometer-sized accelerometer, for example, on a single integrated chip. Such a device may include a suspended cantilever beam or proof (seismic) mass with some type of deflection sensing and circuitry. With such a device, a reaction force on the accelerometer causes it to accelerate, and the beam or the proof weights deflect. The deflection can be measured as an analog and/or digital signal. Once the beam or mass has deflected sufficiently to reach a deflection point, an electrical pulse is generated to restore the beam or mass to the neutral mass. This pulse can be saved and/or transferred out of the device 100 via the I/O 108. The output signal of the sensor 110 may include one or more signals such as analog and/or digital signals indicative of the acceleration.

Other methods of building MEMS based accelerometers are available. For example, in another approach a small heater at the bottom of a very small dome heats the air inside the dome to cause it to rise. Thermocouples on the dome determine where the heating error reaches the dome and the deflection off of dead center is a measure of the acceleration or specific force applied to the object. MEMS Accelerometers are available in a wide variety of ranges up to thousands of g's.

An action identifier 114 identifies a suitable action based on the output of the sensor 110. One or more preset actions, also referred to as a list of actions, may be stored in an action bank 116. Additionally or alternatively, a set of rules or the list of actions may be stored in the memory 112, and the control component 106 may determine a suitable action based on the information from the sensor 110 and the rules. Additionally or alternatively, machine learning may be used determine a suitable action based on the information from the sensor 110. Examples of suitable machine learning techniques include techniques based on classifiers (e.g., explicitly and/or implicitly trained), probabilities, costs functions, utility, statistics, neural networks, and/or the like. Generally, the output signal of the sensor 110 can be mapped to a programmable action, and the device can be programmed to operate based on the output of the sensor 110 and the mapping, and/or other information. For example, other factors may include time duration in which a flashlight is in a particular state, the speed at which the flashlight transitions into a state, how often (the frequency) the flashlight is in a particular state, as well as other factors my additionally or alternatively be used.

The following provides various non-limiting examples of suitable actions for various devices based on the information provided by the sensor 110.

In one instance, the sensor 110 may be used to determine the orientation of the device 100 (as an event), and this information can be used to determine whether and/or how to operate the load 104, as one or more actions. For instance, in FIG. 2 the device 100 is a flashlight 200, wherein the load 104 includes at least two light sources 202, the power source 102 includes a battery(s) 204, and the sensor 110 includes a MEMS based accelerometer 206. For clarity and sake of brevity, the control component 106, the memory 112, the action identifier 114, and the action bank 116 are collectively referred to as management component 208. Other lighting devices such as headlights, desk lamps, floor lamps, sconce lights, pendent lights, etc. are also contemplated. In this example, a first light source 202₁ is positioned at a front end of the flashlight 200 so as to emit light in a direction generally parallel to a longitudinal axis of the flashlight, and a second light source 202₂ is positioned so as to emit light in a direction generally perpendicular to the longitudinal axis of the flashlight. Although the light sources 202₁ and 202₂ are shown as separate entities, in another embodiment, they may be part of the same light source, wherein the light emitted therefrom is selectively directed in different directions.

In one instance, an inclination or tile angle is sensed by the accelerometer 206 and identified as an event, and the control component 106 can control the light sources 202 as one or more actions based on the sensed inclination. The inclination may provide information related to the orientation of the flashlight 200 with respect to a frame of reference. For instance, from the output of the accelerometer 206 it may determined that the orientation of the flashlight is such that the first light source 202₁ is on and the second source 202₂ is off, vice versa, or both or neither of the light sources is on. The inclination can also be used to otherwise control the flashlight 200.

In another instance, a periodic or random mechanical oscillation such as a vibration is sensed by the accelerometer 206 and identified as an event, and the control component 106 can control the light sources 202 by performing one or more actions based on the sensed mechanical oscillation (event), including a magnitude thereof. For instance, a first sensed vibration may be indicative of human touch such as a finger tap on the flashlight 200 that may produce a signal that turns the flashlight 200 on, a second sensed vibration may adjust the light intensity and/or the number of lights turned on or off, a third sensed vibration may produce a signal that turns the flashlight 200 off, etc. In another example, different audible signals may cause different vibrations and, the control component 106 controls the light source based on the vibration and, thus, the particular audible signal. Likewise, the sensed vibration can also be used to otherwise control the flashlight 200.

In another instance, a transient physical excitation or pulse, such as a shock or sudden acceleration or deceleration, is sensed by the accelerometer 206, and the control component 106 can control the light sources 202 based on the sensed excitation, including a magnitude thereof. For example, a first sensed excitation may be indicative of an object impacting the flashlight 100, which may result in no particular action or the activation of one or more visual or audible signals. A second sensed excitation may be indicative of a human dropping the flashlight, which may result in the activation of a “find me” light and/or a “find me” illumination sequence. Another sensed excitation may result in a signal indicative of an earthquake, which may automatically turn one or more light sources of the flashlight on. Another sensed excitation may result in a signal that indicates that an explosive has been detonated, a firearm has been discharged, a person is screaming, etc. This may result in the flashlight 200 operating in a distress mode, for example, selectively activating a light(s) of the flashlight 200, invoking a wireless device such as a cell phone, pager and/or the like to automatically send a signal, etc.

In another embodiment, the accelerometer 204 may be used as a pedometer to count the number of steps, as one or more actions, when walking, jogging and running by producing signals with peak amplitudes or spikes as events in response to each step. Such information can also be used to by the control component 106 to control the light sources 202. For example, the action bank 116 may include actions mapped to step rate. By way example, when moving at a desired or preset rate, the control component 106 may operate the light sources 202 in accordance with a first programmed operation, and when moving at a different rate, the control component 106 may operate the light sources 202 in accordance with a different programmed operation.

In another embodiment, the accelerometer 204 measures the temperature of the device 100 via thermal expansion, which results in motion. Such a MEMS device may be formed with a doped Single Crystal Silicon or Polysilicon as a complex compliant member, wherein an increase in temperature is achieved internally by electrical resistive heating or externally by a heat source capable of locally introducing heat. By measuring temperature, the sensor 110 can be used to control the power provided to the load 202 based on one or more temperature thresholds set in accordance with temperatures indicative of an electrical current short, an environment temperature outside of a specified operating range, and/or other condition. As such, the device 100 may be inherently safe in relation to preset conditions.

Although the above examples were described in the context of transition from a static to a dynamic state, it is to be understood that a transition from a dynamic state to a static state may likewise be sensed and used to operate the device 100 according to programmable actions, rules, and/or artificial intelligence.

It is to be appreciated that a relatively more traditional accelerometer, for example, one based on capacitive or piezoresistive technology that measures the movement of a micro-mechanical mass structure, can additionally or alternatively be used in the device 100.

It is also to be appreciated that a motion, light, sound, and/or other sensor can be used with the device 100 in addition to the sensor 110.

Operation is described in connection with FIG. 3.

At 302, a MEMS based accelerometer located in a lighting device determines an external force of the lighting device based on one or more of an acceleration, vibration, shock, tilt, inclination or temperature of the accelerometer.

At 304, control component controls power supplied from a power supply of the device to a load of the device based on the determined external force.

It is also to be appreciated that the device 100 could be a fixed mounted light able to detect the approach of an object such as a person walking up to it. In response, the device 100 may illuminate one or more light sources and/or invoke other functionality. This may be useful in illumination of hallways stairs and the like.

It is to be appreciated that the signal from the accelerometer can be variously employed. In another embodiment, the signal is used to toggle a lighting device between a spot light mode and a flood light mode, an on mode and an off mode, a combination thereof, and/or one or more other modes. Using the signal, this can be achieved without a manual input by the operator of the lighting device.

By way of example, a portable lighting device may be programmed so that while the user is walking at a steady pace and holding the portable lighting device with a resultant horizontal beam +/−5 degrees, the lighting device operates with a 50/50 spot/flood blend. With a faster pace, the lighting device operates with a 60/40 spot/flood blend. With a slower pace, the lighting device operates with a 40/60 spot/flood blend.

By way of another example, a portable head light may be programmed so that while the user is walking, the lighting device operates as a spot light. However, when the user jog, the lighting device operates with a 75/25 spot/flood blend, and when the user runs, the lighting device operates as a spot light. Head tilt may also used to determine the operational mode. Of course, the above examples are only provided for explanatory purposes and are not limiting.

For instance, in another example when the pace is extremely slow and a positive acceleration is detected in the Z axis, the lighting device output might be a 75/25 spot/flood blend, as this pattern may be mapped to a mode for illuminating an object at a distance. The ratio might be a function of the light angle as well. For example, the higher the increase in angle insinuates the user is looking up and, therefore, a spot light mode is activated. If the device angle is decreased and a negative acceleration is detected, this likely means the user is finished with looking up, and the lighting device transitions back to the previous mode.

In one instance, the modes could be stored in a register or the like so that the portable lighting device would resume the previous setting per an on-board microcontroller's shift register. In another instance, this feature could be used similar to a cruise control on a car in that it can be turned on and off by the user so that the user can user this feature when the user desires to the use the feature, but otherwise, the user can use other approaches to setting a desired mode of operation. In another instance, the portable lighting device could have a switch or certain user presets in order to initiate the “Operator Assist” mode. Various other scenarios and/or algorithms are also contemplated possible.

As noted herein, the accelerometer can be 2 or 3 dimensional, and can be similar to those used in electronic products such as games, etc. The signal may indicate a change in acceleration due to tilt or other movement. The particular pattern may be based on behavioral patterns as humans can be somewhat predictable in terms of their intuitive hand motions and gestures. The modes of operation can be default and/or user defined. Machine learning techniques may also be used to map patterns to functional operations of the lighting device.

It is to be appreciated that using the accelerometer may eliminate the need to continually electronically focus a lighting device. Such functionality may be useful for a high-end hunter or a kayaker attempting to row a boat with both hands and find a channel marker in the fog. In the latter case, if the kayaker tilts his head up, the lighting device can be programmed to produce a light output suitable for finding the channel marker, and if the kayaker keeps his head down and a steady “pace” is detected, the lighting device can be programmed to produce a light output suitable during rowing.

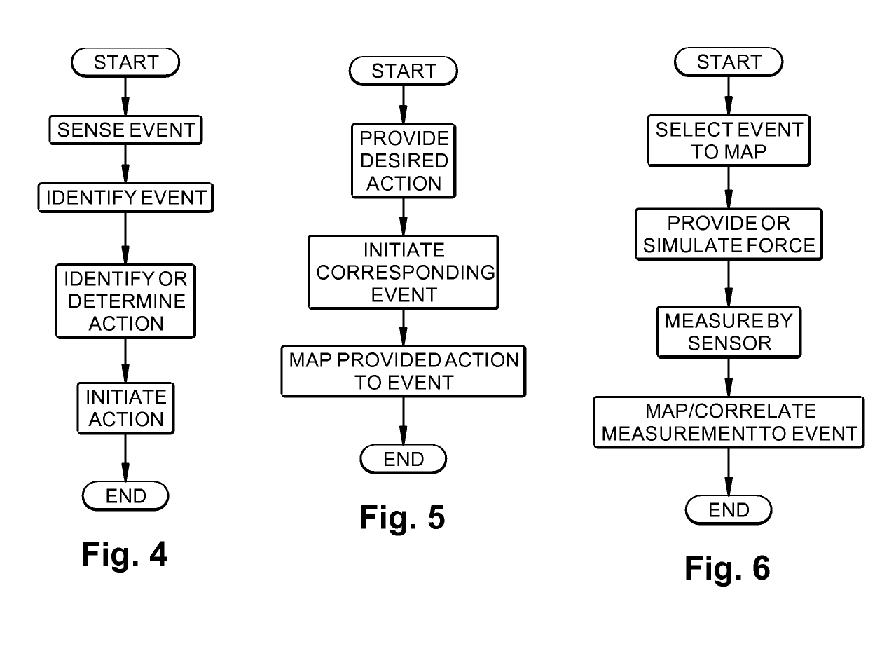

FIG. 4 is a flow diagram of a method 400 of operating a device. The method 400 can be performed with the systems and devices shown above, including those shown in FIGS. 1 and 2. The method 400 can also be employed by the devices shown above, including those shown in FIGS. 1 and 2.

The method 400 begins at block 402 where an event is sensed. A sensor, such as the sensor 110, is employed to sense or measure an event and obtain measurement information. An example of a suitable sensor is an accelerometer, including single and multiple axis accelerometers, or other similar devices. In one example, the sensor measures a force on the sensor due to acceleration, vibration, shock, tilt, inclination, temperature, and the like. The event is that which causes the sensed activity to occur. The event includes, for example, dropping, tilting, inclination, shock, temperature, looking up, and the like. A control component, such as the control component 106, can monitor and capture the sensor measurement information.

The event is identified at block 404. The data or measurement obtained by the sensor is correlated to identify the event by a suitable process or mechanism. The control component 106 can be employed to perform such a correlation. In one example, a table of events and corresponding sensor measurements are referenced in order to identify the event. In another example, a neural network is trained to classify or identify the events and the neural network identifies the event based on the sensor measurements.

An action is determined or identified according to the identified event at block 406. The control component 106 can interact with an action identifier, such as the action identifier 114 to determine or identify the action to be performed. The action identifier 114 can reference the action bank 116 to obtain a list of possible actions to choose from.

The action includes, for example, turning on a light, turning off a light, playing a sound, adjusting focus of a flashlight, adjusting an illumination pattern of a flashlight, adjusting beam intensity, adjusting a beam size/shape, adjusting a color of light emitted, activating varied light sources and the like. The action is typically a desired response in view of the event. The action is generally, but not necessarily, one of several possible actions for a device. The action can include a sequence of individual actions, such as adjusting light intensity and adjusting a beam size/shape. A list or table of actions can be maintained and correlated to a list of events. The table is then referenced to determine the action there from. In another example, a neural network is trained to classify or identify the correlation between the actions and the events.

The determined action is initiated or performed at block 408. For example, the device may be turned on, off, a light switched from a flood mode to a spot mode, and the like. As another example, a mechanism can move lenses to adjust focusing or adjust beam size. In another example, the control component 106 adjusts the power provided to the load 104.

FIG. 5 is a flow diagram illustrating a method 500 of mapping events. The method 500 can be employed within or without the method 400 of FIG. 4. Further, the method 500 can be performed with the systems and devices shown above, including those shown in FIGS. 1 and 2. The method 500 can also be employed by the devices shown above, including those shown in FIGS. 1 and 2.

The method 500 begins at block 502 where an event to be mapped is selected. Some examples of events are shown above. The selected event is typically one of many events to be mapped. As another example, the event can include a user request to turn a device on.

A force or movement corresponding to the event is initiated and measured at block 504. The force includes, for example, tilting, shaking, and the like.

The force or movement is measured by one or more sensors at block 506. In one example, the sensor 110 is employed to measure and provide measurement information to the control component 106. The measurement information includes the sensor measurements and time/duration of the measurements.

The provided force is measured and is mapped or correlated to the selected event at block 508. The control component 106 can be employed to perform the correlation. The force includes, for example, tilting, shaking, and the like. As one example, shaking is mapped to a user request to turn a device on. The correlation can then be stored in a table or other structure or learned as part of a neural network. In one example, the control component 106 stores the correlation information for the event and measurement into the memory 112

FIG. 6 is a flow diagram illustrating a method 500 of correlating actions to events. The method 600 can be employed within the method 400 of FIG. 4. Further, the method 500 can be performed with the systems and devices shown above, including those shown in FIGS. 1 and 2. The method 600 can also be employed by the devices shown above, including those shown in FIGS. 1 and 2.

The method 600 begins at block 602 where an action is provided or selected. The action can be selected from a list of actions, such as a list stored in the action bank 116. Examples of actions are listed above.

An event is initiated or selected at block 604. Examples of suitable events are provided above. The provided action is mapped or correlated to the event at block 606. It is noted that multiple events can be mapped to a single action and a single event can be mapped to multiple actions. The correlation can then be stored in a table or other structure or learned as part of a neural network. In one example, the control component 106 interacts with the action identifier 114 to map events and actions.

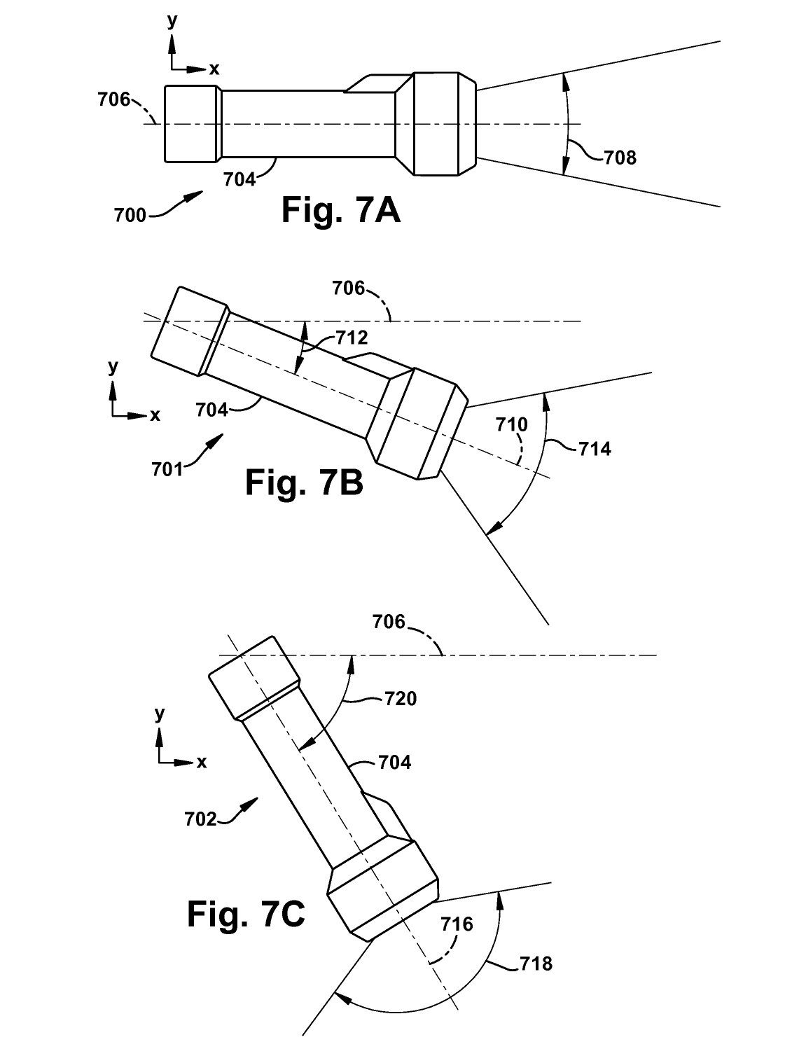

FIGS. 7A, 7B, and 7C depict an example of events and actions for a lighting device 703. The lighting device 703 is an illustrative example of devices 100 and 200. The device 703 includes a body housing 704 and a light housing 702. The body housing 704 is shown as tubular shaped only as an example and houses one or more batteries (not shown). The light housing 702 emits a beam of light having a selected intensity, focus pattern, and beam shape. Operation of the lighting device 703 can be controlled without mechanical/physical switch and/or button interaction and is instead controlled by various events that result in corresponding actions.

View 700 of FIG. 7A shows the light housing 702 emitting light in a forward (+x) direction with a spot type beam 707 having a relatively narrow beam angle 708. For example, the narrow beam angle 708 can be 25 degrees or less from edge to edge of the beam 707. In this example, an event of the lighting device being positioned along the x/horizontal axis (706) causes the action of the beam of light emitted from the light housing 702 to change to the spot type beam 707. A centerline of the beam 707 lies along the horizontal axis 706.

View 701 of FIG. 7B shows the light housing 702 emitting light in a somewhat downward or tilted angle 710 from the horizontal axis 706. An event of tilting to an angle 710 causes the action of a flood type beam 715 being emitted from the light housing 702. In this example, the flood type beam 715 has a wide beam angle 714, such as, for example, greater than 45 degrees from beam edge to beam edge. A centerline of the beam 715 lies along a tilted axis 710 at the angle 712 from the horizontal axis.

View 705 of FIG. 7C shows the light housing 702 emitting light in a downward or tilted angle 720 from the horizontal axis 706. An event of tilting to an angle 720 causes the action of a flood type beam 719 being emitted from the light housing 702. In this example, the flood type beam 715 has a wide beam angle 714, such as, for example, greater than 50 degrees from beam edge to beam edge. A centerline of the beam 719 lies along a tilted axis 716 at the angle 720 from the horizontal axis.

The above FIGS. 7A, 7B, and 7C show how downward tilting of the device 703 change the operation of the device, adjusting the shape of the beam, without, for example, rotation of a head, movement of a switch, and the like.

Other events and actions, including those described above in FIGS. 1-7 are also contemplated with the lighting device 703. Some other possible events and actions include shaking the housing 704 left and right as a “no gesture” to turn the lighting device 703 off and shaking the housing 704 up and down as a “yes gesture” to turn the lighting device 703 on.

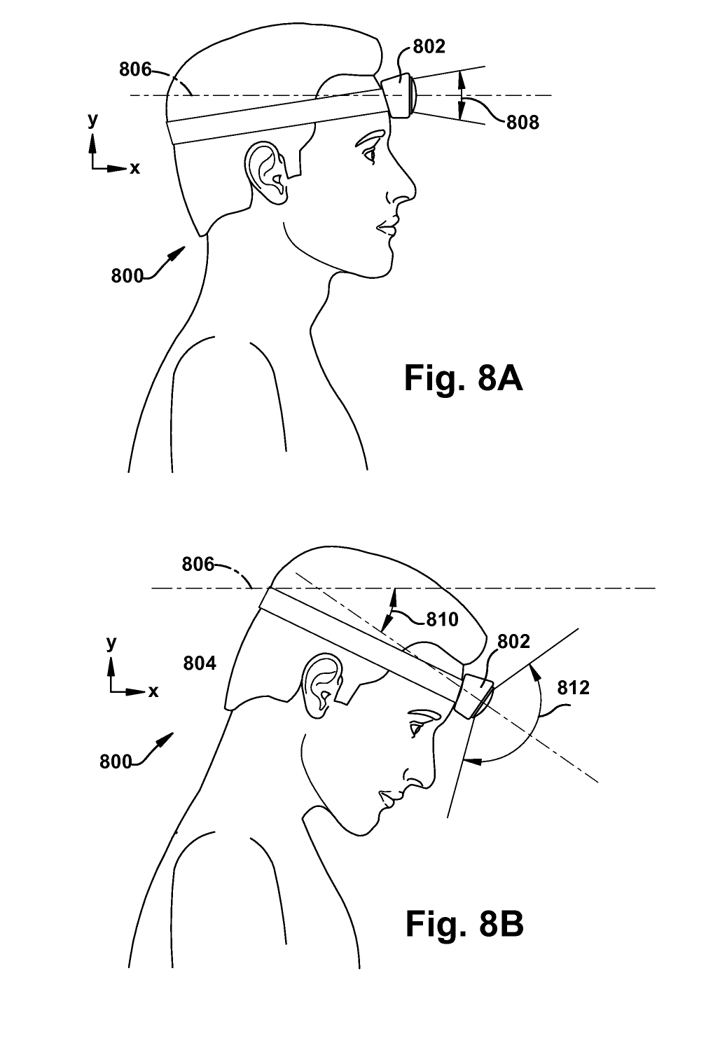

FIGS. 8A and 8B depict an example of events and actions for a headlight or headlamp lighting device 803. The headlight 803 is an illustrative example of devices 100 and 200 and includes a light housing 802 and a strap 804. The strap 804 fits around a users head and fastens or supports the light housing 802. The light housing 802 emits a beam of light having a selected intensity, focus pattern, and beam shape. Operation of the headlight 803 can be controlled without mechanical/physical interaction and is instead controlled by various events that result in corresponding actions.

View 800 of FIG. 8A shows the light housing 802 emitting light in a forward (+x) direction with a spot type beam 807 having a relatively narrow beam angle 808. For example, the narrow beam angle 808 can be 30 degrees from edge to edge of the beam 807. In this example, an event of the headlamp being positioned along the x/horizontal axis (806) causes the action of the beam of light emitted from the light housing 802 to change to the spot type beam 807. A centerline of the beam 807 lies along the horizontal axis 806.

View 801 of FIG. 8B shows the light housing 802 emitting light in a somewhat downward or tilted angle 810 from the horizontal axis 806. An event of tilting to an angle 810 causes the action of a flood type beam 813 being emitted from the light housing 802.

In this example, the flood type beam 813 has a wide beam angle 812, such as, for example, greater than 45 degrees from beam edge to beam edge. A centerline of the beam 813 lies along a tilted axis 816 at the angle 810 from the horizontal axis.

Other events and actions, including those described above in FIGS. 1-7 are also contemplated with the headlamp 803. Some other possible events and actions include shaking a users head left and right as a “no gesture” to turn the headlamp 803 off and shaking a users head up and down as a “yes gesture” to turn the headlamp 803 on.

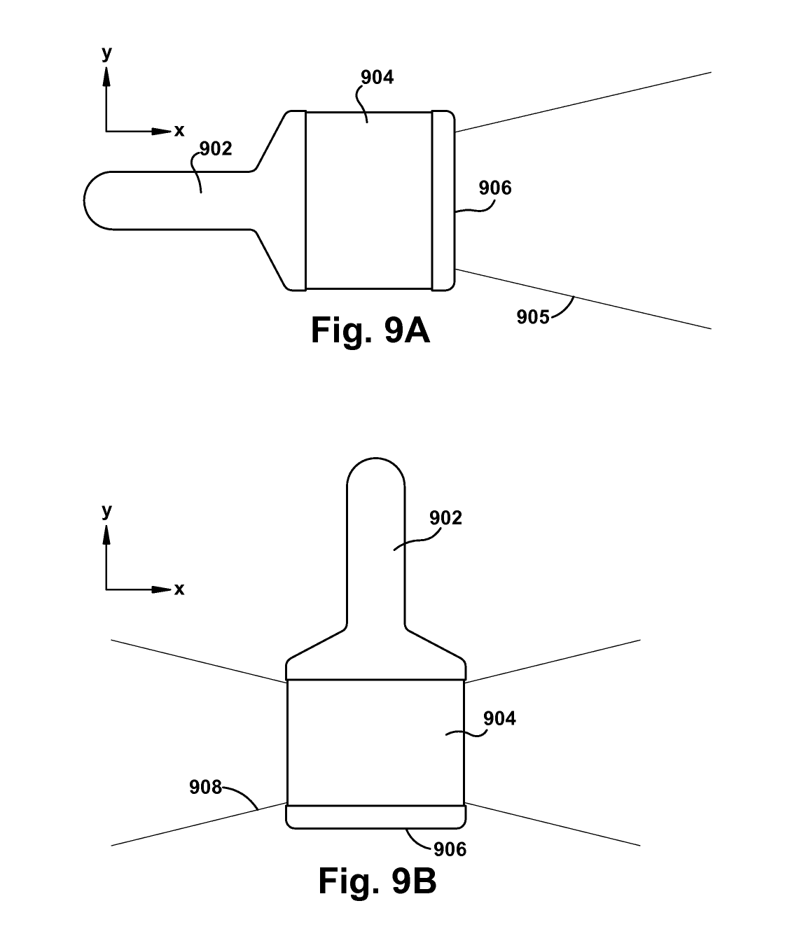

FIGS. 9A and 9B depict an example of events and actions for a lighting device 903. The headlight 903 in this example is a lantern and is an illustrative example of devices 100 and 200. The headlight 903 includes a housing 902, an area light mechanism 904 and a spot light mechanism 906. The area light mechanism 904 emits a light beam having a wide dispersal pattern or beam, for example, greater than 45 degrees. The spot light mechanism 906 emits a light beam having a narrower edge to edge angle, for example, less than 45 degrees.

The beams of light generated by mechanisms 904 and 906 have a selected intensity, focus pattern, and beam shape. Operation of the device 903 can be controlled without mechanical/physical interaction and is instead controlled by various events that result in corresponding actions.

View 900 of FIG. 9A shows the spot light mechanism 906 emitting a light beam 907 in a generally forward (+x) direction. The light beam has a relatively narrow beam shape. The device 903 is show lying along a horizontal axis that causes several actions to occur. A first action is to turn off the area light mechanism 904. A second action is to turn on the spot light mechanism 906.

View 901 of FIG. 9B shows the area light mechanism emitting a light beam 909 having a relatively wide edge to edge angle. The area light beam is relatively wide in shape. The device 903 is shown lying along a vertical axis that causes the spot light mechanism 906 to turn off and the area light mechanism 904 to turn on.

The views 900 and 901 show how rotation of the device alters the operation of the area light mechanism 904 and the spot light mechanism 906 and the device.

Other events and actions, including those described above in FIGS. 1-7 are also contemplated with the device 903. Some other possible events and actions include shaking the device 903 left and right as a “no gesture” to turn the device 903 off and shaking the device up and down as a “yes gesture” to turn the device 903 on.

The application has been described with reference to various embodiments. Modifications and alterations will occur to others upon reading the application. It is intended that the invention be construed as including all such modifications and alterations, including insofar as they come within the scope of the appended claims and the equivalents thereof.

What is claimed is:

1. An electrical device, comprising:
a sensor that measures a force on the sensor to provide measurement information;
a list of events;
a list of actions; and
a control component coupled to the sensor that identifies an event from the measurement information, logs the event and selects an action based on the identified event.

2. The device of claim 1, further comprising a load, wherein the control component 106 applies power to the load based on the selected action.

3. The device of claim 1, wherein the sensor is part of a Micro Electro Mechanical Systems (MEMS) device.

4. The device of claim 1, wherein the sensor includes at least one accelerometer.

5. The device of claim 1, wherein the sensor includes an inertial sensor.

6. The device of claim 2, wherein the load includes one or more light sources.

7. The device of claim 6, wherein the control component operates a first of the one or more light sources differently than a second of the one or more light sources based on a first sensed force.

8. The device of claim 6, wherein the control component operates a first of the one or more light sources based on a sensed force.

9. The device of claim 6, wherein the control component 106 controls an illumination of a first of the light sources in accordance with a first mode for a first sensed force and in accordance with a second different mode for a second different sensed force.

10. The device of claim 1, wherein the external force is indicative of a one or more of acceleration, vibration, shock, tilt or inclination of the device.

11. The device of claim 1, further comprising an input/output component coupled to the control component.

12. The device of claim 1, further comprising a power source coupled to the control component.

13. The device claim 1, wherein the power source comprises one or more batteries.

14. A flashlight device, comprising:
a battery receiving region;
a light source;
an integrated chip, including:
control circuitry; and
a MEMS based accelerometer, wherein the MEMS device determines an external force on the accelerometer, and the control circuitry controls the light source based on the determined force.

15. The device of claim 14, further including a second light source, wherein the control circuitry operates the first and second light sources differently based on the force.

16. The device of claim 14, wherein the control circuitry selectively turns the light source on or off based on the force.

17. The device of claim 14, wherein the control circuitry communicates with at least one of a cell phone or a pager based on the force.

18. The device of claim 14, wherein the control circuitry causes a message to be transmitted based on the force.

19. An headlight lighting device, comprising:
a housing;
a light source within the housing;
a strap connected to the housing;
a motion sensor within the housing that measures hand motions and gestures as measurement information;
a plurality of actions comprising off and on;
a control component within the housing coupled to the sensor that identifies an gesture from the measurement information, logs the event and selects one of the plurality of actions according to the identified gesture.

20. The headlight of claim 19, the identified gesture comprising a yes gesture.
